(19) United States
(12) Patent Application Publication
(10) Pub. No.: US 2005/0007011 A1
(43) Pub. Date: Jan. 13, 2005

(54) Electrode compositions

(76) Inventor: Salvatore Cina, Rennes (FR)

Correspondence Address: James P Zeller;Marshall Gerstein& Borun, 6300 Sears Tower, 233 South Wacker Drive, Chicago, IL, 60606-6357, US

(21) Appl. No.: 10/484,763

(22) PCT Filed: Jul. 24, 2002
(86) PCT No.: PCT/GB02/03394

(30) Foreign Application Priority Data
Jul. 26, 2001 (GB) 0118258.3

(51) Int. Cl. H05B 33/14

(52) U.S. Cl. 313/504; 313/503; 313/506

(57) ABSTRACT

A display device including an anode, a cathode, and a region of an organic electroluminescent material located between the anode and the cathode, wherein the organic electroluminescent material is a blue-light emitter, and the cathode includes a first layer and a second layer located between the first layer and the organic electroluminescent material, the first layer containing aluminum and the second layer containing at least one of sodium fluoride and potassium fluoride.

This invention relates to compositions of electrodes for light-emissive devices, especially for devices that emit light by means of light-emissive organic materials.

An emerging class of display devices uses organic materials for light emission. Light-emissive organic materials are described in PCT WO90/13148 and U.S. Pat. No. 4,539,507, the contents of both of which are incorporated herein by reference. The basic structure of these devices is a light-emissive organic layer, for instance a film of a poly(p-phenylenevinylene (“PPV”), sandwiched between two electrodes. One of the electrodes (the cathode) injects negative charge carriers (electrons) and the other electrode (the anode) injects positive charge carriers (holes). The electrons and holes combine in the organic layer, generating photons. In PCT WO90/13148 the organic light-emissive material is a polymer. In U.S. Pat. No. 4,539,507 the organic light-emissive material is of the class known as small molecule materials, such as (8-hydroxyquinolino)aluminium (“Alq3”). In a practical device, one of the electrodes is typically transparent, to allow the photons to escape the device.

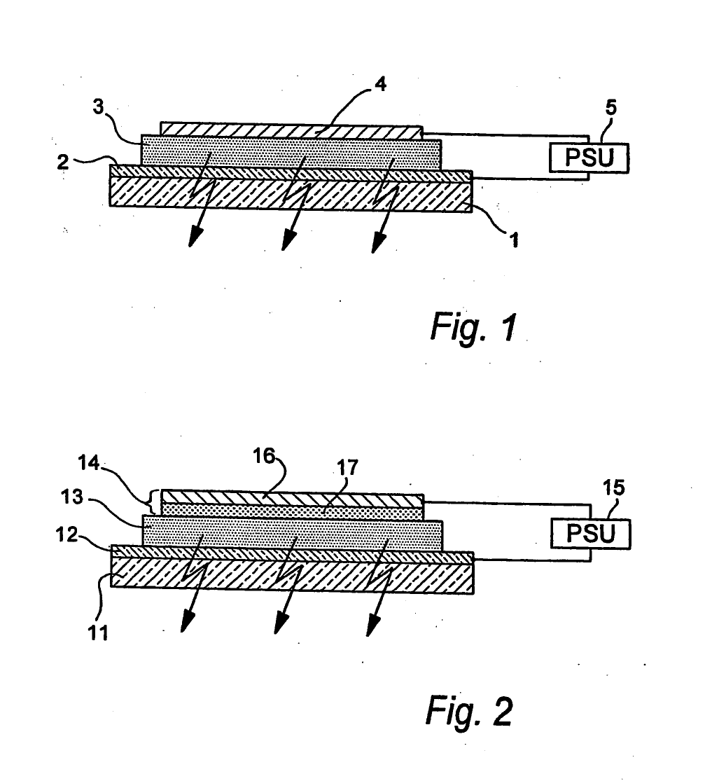

FIG. 1 illustrates the cross-sectional structure of a typical organic light-emissive device (“OLED”). The OLED is typically fabricated on a glass or plastic substrate 1 coated with a transparent first electrode 2 such as indium-tin-oxide (“ITO”). Such coated substrates are commercially available. This ITO-coated substrate is covered with at least a layer of a thin film of an electroluminescent organic material 3 and a final layer forming a second electrode 4, which is typically a metal or alloy. Other layers can be added to the device, for example to improve charge transport between the electrodes and the electroluminescent material. When a voltage is applied between the electrodes from a power supply 5 one of the electrodes acts as a cathode and the other as an anode.

The nature of the electrodes has a strong influence on the efficiency of the device. For the cathode electrode a number of materials have been proposed, with materials having a low work-function being generally preferred.
U.S. Pat. No. 4,539,507 suggests cathodes of metals such as indium, silver, tin, lead, magnesium and aluminium.
WO 00/48257 describes a trilayer cathode having a layer of aluminium, a layer of calcium and a layer of lithium or magnesium fluoride.
EP 0 822 603 A proposes a bilayer cathode which includes a thin fluoride layer and a thick conductive layer. The fluoride can be selected from the group of alkaline fluorides and alkaline earth fluorides. The conductive layer can be selected from the group of elemental metals, metal alloys and conductive materials. For the fluoride layer thicknesses in the range 0.3 to 5.0 nm are taught.

According to one aspect of the present invention there is provided a display device comprising: an anode; a cathode; and a region of an organic electroluminescent material located between the anode and the cathode; wherein: the organic electroluminescent material is a blue-light emitter; and the cathode comprises a first layer and a second layer located between the first layer and the organic electroluminescent material, the first layer comprising aluminium and the second layer comprising at least one of sodium fluoride and potassium fluoride.

According to a second aspect of the present invention there is provided a method for forming a display device, comprising: forming a structure comprising an anode and a region of an organic electroluminescent material; depositing in contact with the organic electroluminescent material a cathode comprising a first layer and a second layer located between the first layer and the organic electroluminescent material, the first layer comprising aluminium and the second layer comprising at least one of sodium fluoride and potassium fluoride.

Preferably the first layer consists essentially of aluminium.

Preferably the second layer consists essentially of sodium fluoride and potassium fluoride. The second layer may comprise only one of sodium fluoride or potassium fluoride.

The thickness of the first layer is suitably in the range from 200 to 700 nm, preferably in the range from 300 to 600 nm. The thickness of the second layer is suitably in the range from 2 to 6 nm, preferably in the range from 3 to 5 nm.

The organic electroluminescent material is preferably a polymer or oligomer comprising fluorene units, and is most preferably a polyfluorene. The organic electroluminescent material could usefully be a blue emitting copolymer of one or more fluorenes and one or more triarylamines. The fluorene units preferably contribute to light emission from the material.

The device may suitably have its peak intensity of emission at a wavelength in the region 400 to 500 nm. The device may suitably emit with a colour having 1931 CIE coordinates in the range 0.1≦x≦0.2, 0.00≦y≦0.1, preferably in the range 0.12≦x≦0.18, 0.02≦y≦0.8 and most preferably around x=0.15, y=0.05.

The device may constitute a blue pixel of an RGB (red, green, blue) display.

The device may comprise a first power supply coupling on the anode and a second power supply coupling on the first layer of the cathode.

The second layer is preferably in contact with the organic electroluminescent material. The first layer is preferably in contact with the second layer. The first layer is preferably separated by the second layer from the organic electroluminescent material, so the first layer is preferably not in contact with the organic electroluminescent material.

The first layer is deposited by evaporation on to the organic electroluminescent material. The deposition rate is preferably between 1 and 5 Å/s, preferably around 2 Å/s.

Some or all of the first layer is advantageously deposited by evaporation. Preferably the evaporation rate is less than 1 Å/s . Preferably the material from which the first layer is to be deposited is offgassed prior to evaporation, for example by being held at an elevated temperature below the evaporation temperature. The elevated temperature may conveniently be above 500° C. and the material may be held at that temperature or above for 5 minutes or more.

Some or all of the second layer is advantageously deposited by evaporation. Preferably the evaporation rate is less than 1 Å/s . One advantageous route is to deposit part of the first layer, to a thickness of 100 nm or more, by evaporation and/or at a deposition rate of less than 1 Å/s. That part of the first layer suitably contacts the second layer. Conveniently a subsequent first portion of the second layer can be deposited (e.g. by evaporation) at a rate greater than 5 Å/s. Preferably the material from which the second layer is to be deposited is offgassed prior to evaporation, for example by being held at an elevated temperature below the evaporation temperature. The elevated temperature may conveniently be above 500° C. and the material may be held at that temperature or above for 5 minutes or more.

The organic electroluminescent material is suitably a polymer material, preferably semiconductive polymer material and preferably a conjugated (either fully or partially) polymer material. Alternatively, the electroluminescent material could be a non-polymeric organic material, such as a small molecule material, an oligomer material or a monomer material. The organic electroluminescent material may comprise one, two or more electroluminescent components, for instance as a mixture or a copolymer. The polymer could be a copolymer including fluorene units.

The device may suitably include one or more additional layers. One example of such an additional layer is a charge transport layer, which could be located between an electrode layer and the light-emissive layer. The or each charge transport layer may suitably comprise one or more polymers such as polystyrene sulphonic acid doped polyethylene dioxythiophene (“PEDOT-PSS”), poly(2,7-(9,9-di-n-octylfluorene)-(1,4-phenylene-(4-imino(benzoic acid))-1,4-phenylene-(4-imino(benzoic acid))-1,4-phenylene)) (“BFA”), polyaniline and PPV.

The anode electrode may suitably have a work function of greater than 4.3 eV. That electrode may comprise a metallic oxide such as indium-tin oxide (“ITO”) or tin oxide (“TO”).

At least one of the electrodes is suitably light transmissive, and preferably transparent, suitably to light emitted from the light-emissive regions.

The blue light emitting devices of the present invention are particularly suited to use as a white light source when combined with a phosphor-containing covering. An example of such a white light source is disclosed in WO00/33390. White light sources have application in a wide range of residential, commercial and industrial settings.

The present invention is also directed to a white light emitting device comprising:
an organic light emitting device comprising an anode, a cathode and a region of an organic electroluminescent material located between the anode and the cathode; wherein the organic electroluminescent material is a blue-light emitter; and
the cathode comprises a first layer and a second layer located between the first layer and the organic electroluminescent material, the first layer comprising aluminium: and the second layer comprising at least one of sodium fluoride and potassium fluoride, the white light emitting device further comprising a phosphor-containing covering at least partially covering the organic light emitting device, the phosphor-containing covering suitable for partially absorbing light emitted by the organic electroluminescent material and emitting light at longer wavelengths such that the overall emission from the device is white. Preferably the phosphor-containing covering comprises green-emitting phosphors and red-emitting phosphors. The green emitting phosphor preferably has an emission peak at 530-555 nm. The red emitting phosphor preferably has an emission peak at 610-620 nm. For the purposes of the present invention white light is considered to be light having 1931 CIE coordinates of 0.33, 0.41 and/or a colour temperature of 3000-4100° K. The phosphor-containing covering is preferably situated on the viewing side of the light emitting device and preferably covers at least 50% of the viewing side of the device.

The present invention will now be described by way of example with reference to the accompanying drawings, in which:

FIG. 1 shows the basic structure of an OLED;

FIG. 2 illustrates an OLED having a bilayer cathode;

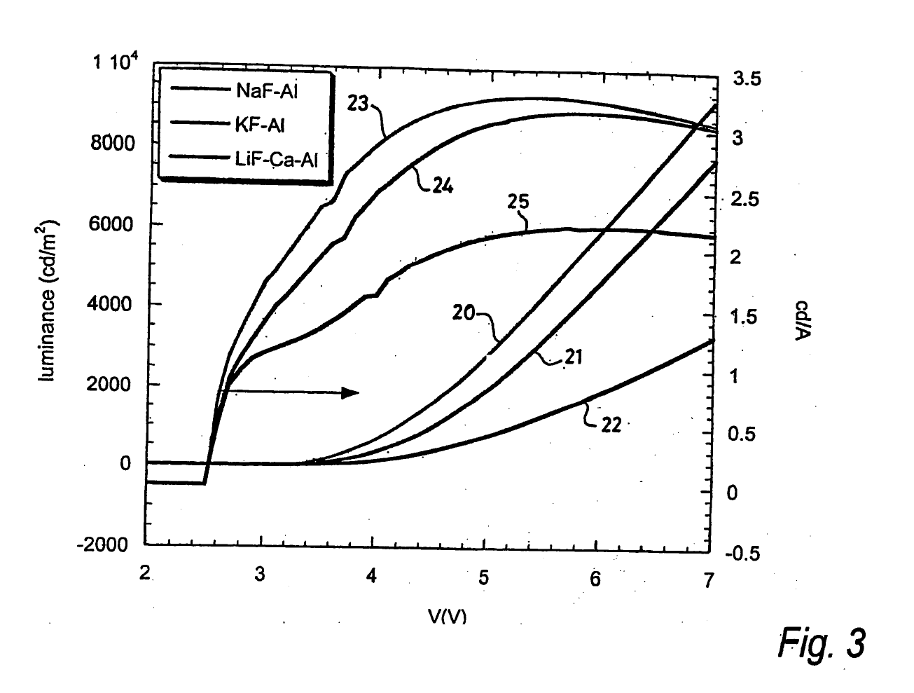

FIG. 3 is a plot of luminance and efficiency against applied voltage for devices having cathodes of various materials; and

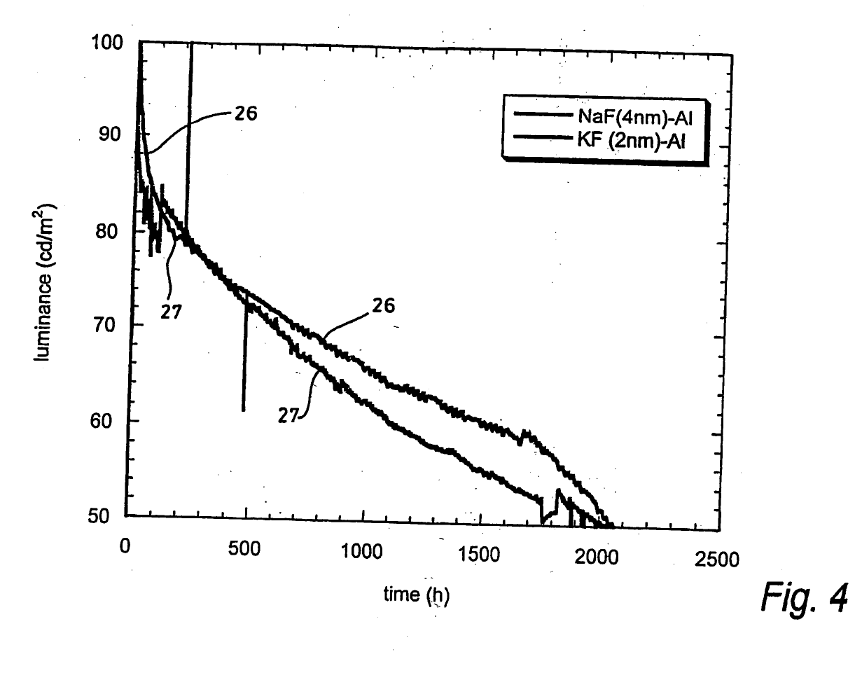

FIG. 4 is a plot of luminance against time for devices having cathodes of various materials.

FIG. 2 shows an organic light-emissive device having a bilayer cathode. The device comprises a transparent glass or plastics substrate 11. Over the substrate is a transparent anode electrode 12 formed of ITO. Over the anode is a layer 13 of organic light-emissive material 13 and over that is a cathode layer 14. The cathode layer 14 comprises two layers 16, 17. Layer 17 is located between layer 16 and the light-emissive layer 13 and separates layer 16 from layer 13. A power supply 15 is connected between the anode 12 and layer 16 of the cathode 14. The power supply is arranged to apply a voltage between the electrodes so as to make cathode 14 electrically negative with respect to anode 12.

In the cathode, layer 16 is a metal layer. It is formed of aluminium. The thickness of layer 16 is around 100 to 1000 nm, preferably around 200 to 700 nm. Layer 17 is a fluoride layer. It is formed of sodium fluoride or potassium fluoride. The thickness of layer 17 is in the range from 2 to 6 nm, preferably from 3 to 5 nm, and most preferably around 4 nm.

The substrate 11 and the anode electrode 12 may be a pre-prepared commercially available ITO-coated glass sheet. To form the device the light-emissive layer 13 is deposited over the ITO layer. The light-emissive layer can conveniently be deposited from solution, for example by spin coating. Then the cathode is formed over the light-emissive layer.

The cathode is preferably formed by evaporation of the fluoride layer 17 followed by evaporation of the metal layer 16. It has been found to be advantageous to evaporate at least the fluoride layer at a very low rate: preferably less than 1 Å/s, although somewhat higher rates could be used. For best results the first part of the metal layer (suitably the first 100 nm or so of the metal layer) is also deposited at such a low rate. For best results, before the material of each cathode layer is deposited it is outgassed by being held at an elevated temperature below its evaporation point—conveniently around 650 to 670° C.—for around 5 to 10 minutes.

Devices having cathodes in which layer 16 is formed of aluminium and layer 17 is formed of sodium fluoride or potassium fluoride have been found to have markedly better performance than devices having other compositions of cathode, even ones in which the fluoride layer is formed of lithium fluoride. This effect has been found to be especially pronounced when the light-emissive material emits in the blue region of the spectrum. One example of a blue light emitter: a copolymer comprising 10% TFB, 10% PFB, 80% F8, is detailed below with reference to devices A to C. Other examples of blue light emitters are given in D Y Kim et al., Progress in Polymer Science 25 (2000) 1089-1139.

Devices were manufactured having cathode structures as shown in columns 2 and 3 of the following table:

| | Layer | Layer 17 | Luminance/ | Efficiency/ | Luminance/ |
|---|---|---|---|---|---|
| Device | 16 | (thickness) | voltage plot | voltage plot | time plot |
| A | Al | NaF (4 nm) | 20 | 23 | 26 |
| B | Al | KF (2 nm) | 21 | 24 | 27 |
| C | Al | LiF (3 nm) | 22 | 25 | — |

The light-emissive layer for each of these devices comprised a copolymer of 10% TFB (i.e. bis(1,4-phenylene)-4-sec-butylphenylamine), 10% PFB (i.e. 1,4-phenylene-((4-butylphenyl) imino)-1,4-phenylene((4-butylphenyl) imino)-1,4-phenylene)) and 80% F8 (i.e. 9,9-dioctylfluorene). This material is discussed in more detail in WO0/55927.

FIG. 3 plots the luminance and efficiency of the devices against applied voltage (see columns 4 and 5 of the above table). The NaF and KF devices (A and B) show markedly better luminance and efficiency than the LiF device (C).

FIG. 4 plots the luminance of devices A and B over time. Both devices show acceptable lifetimes of around 2000 hours above 50 cd/m². Devices like device C in which the layer 16 is formed of aluminium and the layer 17 is formed of lithium fluoride have been found to give only very short lifetimes in devices of this type.

In comparison to the cathodes described in WO 00/48257 devices A and B have the advantage that they do not include metallic calcium, which is highly reactive and has been found in some circumstances to lead to degradation. Also, it is simpler to manufacture a bilayer cathode than a trilayer cathode. Experiments have shown devices having NaF/Al and KF/Al cathodes to be significantly more efficient than devices having LiF/Ca/Al cathodes.

The light-emissive materials discussed above are preferably organic polymer, small molecule or oligomer materials. Suitable materials include conjugated fluorenes, amines and copolymers thereof.

The cathode material described above can be used in a common cathode device configuration, in which two or more pixels (normally having different emission colours) share a common cathode but have different anodes.

A layer of a charge transport material may be present between the anode and the light-emissive material. The charge transport material could be PEDOT-PSS.

The present invention may include any feature or combination of features disclosed herein either implicitly or explicitly or any generalisation thereof, irrespective of whether it relates to the presently claimed invention. In view of the foregoing description it will be evident to a person skilled in the art that various modifications may be made within the scope of the invention.

1. A display device comprising:
an anode;
a cathode; and
a region of an organic electroluminescent material located between the anode and the cathode;
wherein;
the organic electroluminescent material is a blue-light emitter; and
the cathode comprises a first layer and a second layer located between the first layer and the organic electroluminescent material, the first layer comprising aluminum and the second layer comprising at least one of sodium fluoride and potassium fluoride.

2. A display device as claimed in claim 1, wherein the first layer consists essentially of aluminum.

3. A display device as claimed in claim 1, wherein the second layer consists essentially of sodium fluoride or potassium fluoride.

4. A display device as claimed in claim 1, wherein the second layer comprises sodium fluoride.

5. A display device as claimed in claim 1, wherein the second layer comprises potassium fluoride.

6. A display device as claimed in claim 1, wherein the thickness of the first layer is in the range from 200 nm to 700 nm.

7. A display device as claimed in claim 1, wherein the thickness of the second layer is in the range from 2 nm to 6 nm.

8. A display device as claimed in claim 1, wherein the organic electroluminescent material is a polyfluorene.

9. A display device as claimed in claim 9, wherein the organic electroluminescent material is copolymer of at least one fluorene and at least one triarylamine.

10. A display device as claimed in claim 1, comprising a first power supply coupling on the anode and a second power supply coupling on the first layer of the cathode.

11. A display device as claimed in claim 1, wherein the second layer is in contact with the organic electroluminescent material.

12. A display device as claimed in claim 1 prepared by a process comprising the step of depositing the first layer on to the organic electroluminescent material at a rate less than 1 A/s by evaporation.

13. A method for forming a display device, comprising:
forming a structure comprising an anode and a region of an organic electroluminescent material;
depositing in contact with the organic electroluminescent material a cathode comprising a first layer, and a second layer located between the first layer and the organic electroluminescent material, the first layer comprising aluminum and the second layer comprising at least one of sodium fluoride and potassium fluoride.

14. A method for forming a display device as claimed in claim 13, comprising depositing the second layer by evaporation.

15. A method for forming a display device as claimed in claim 14, comprising depositing the second layer at a rate less than 1 A/s.

16. A method for forming a display device as claimed in claim 14, comprising the step of offgassing material from which the second layer is to be deposited prior to depositing the first layer.

17. A method for forming a display device as claimed in claim 13, comprising depositing the first layer by evaporation.

18. A method for forming a display device as claimed in claim 17, comprising depositing a first part of the first layer to be deposited at a rate less than 1 A/s.

19. A method for forming a display device as claimed in claim 18, wherein the thickness of the first part is at least 100 nm.

20. A method for forming a display device as claimed in claim 18 comprising depositing a subsequent portion of the first layer at a rate greater than 5 A/s.

21. A method for forming a display device as claimed in claim 17, comprising the step of offgassing material from which the first layer is to be deposited prior to depositing the first layer.

22. A method for forming a display device as claimed in claim 13, wherein the organic electroluminescent material is a blue-light emitter.

23. A method for forming a display device as claimed in claim 13, wherein the organic electroluminescent material is a copolymer of at least one fluorene and at least one triarylamine.

24. A white light emitting device comprising:
an organic light emitting device comprising:
an anode;
a cathode; and
a region of an organic electroluminescent material located between the anode and the cathode;
wherein;
the organic electroluminescent material is a blue-light emitter; and
the cathode comprises a first layer and a second layer located between the first layer and the organic electroluminescent material, the first layer comprising aluminum and the second layer comprising at least one of sodium fluoride and potassium fluoride,
the white light emitting device further comprising a phosphor-containing covering at least partially covering the organic light emitting device, the phosphor-containing covering being suitable for partially absorbing light emitted by the organic electroluminescent material and emitting said light at longer wavelengths such that the overall emission from the device is white.

25. A white light emitting device according to claim 24, wherein the phosphor-containing covering comprises green-emitting phosphors and red-emitting phosphors.
